(19) United States
(12) Patent Application Publication
(10) Pub. No.: US 2014/0333296 A1
(43) Pub. Date: Nov. 13, 2014

(54) ROTATING BODY OF MAGNETIC ANGLE DETECTOR, MANUFACTURING METHOD THEREOF AND MAGNETIC ANGLE DETECTOR HAVING THE ROTATING BODY

(71) Applicant: FANUC CORPORATION, YAMANASHI (JP)

(72) Inventor: Akira Nishioka, Yamanashi (JP)

(73) Assignee: FANUC CORPORATION, YAMANASHI (JP)

(21) Appl. No.: 14/263,152

(22) Filed: Apr. 28, 2014

(30) Foreign Application Priority Data
May 9, 2013 (JP) 2013-099652

(51) Int. Cl. G01B 7/30; B24B 19/02; B23F 1/02

(52) U.S. Cl. CPC G01B 7/30; B23F 1/02; B24B 19/02; G01B 2210/00
USPC 324/207.25; 451/47

(57) ABSTRACT

A method for manufacturing a rotating body of a magnetic angle detector, wherein the rotating body can be machined and manufactured with high accuracy without generating burrs, a rotating body manufactured by the method, and a magnetic angle detector having the rotating body. A tooth top surface and a tooth surface to be formed on a rotating body are simultaneously machined by one grinding stone. The grinding stone has a tooth top surface grinding part which machines the tooth top surface and a tooth surface grinding part which machines the tooth surface. The grinding stone is configured to simultaneously grind and machine the tooth top surface and the tooth surface by rotational grinding about an axis.

### BACKGROUND OF THE INVENTION

1. Field of the Invention

The present invention relates to a rotating body of a magnetic angle detector, a manufacturing method thereof, and a magnetic angle detector having the rotating body.

2. Description of the Related Art

As shown in FIG. 7, a typical magnetic angle detector includes a detected part 100 which is a rotating body having a gear shape, and a detecting part 106 with a magnet 102 and a magnetic detecting element 104. Generally, rotating body 100 has a structure similar to a mating gear used for power transmission. As shown in an enlarged portion of FIG. 7, each tooth of rotating body 100 has a tooth top surface 108, a tooth bottom 110 and a tooth surface 112 extending between tooth top surface 108 and tooth bottom 110. In such a magnetic angle detector, as exemplified in FIG. 8, a magnetic flux density between magnet 102 and rotating body 100 is detected by means of two magnetic detecting elements 104 to which voltage Vcc is applied, and a rotational angular position of rotating body 100 can be detected by an output which varies based on the two detected magnetic flux densities.

As described above, the rotating body of the magnetic angle detector has a structure similar as a mating gear used to power transmission. Therefore, such a rotating body may be manufactured by a method similar to a method for manufacturing the mating gear. In the prior art, the tooth top surface and the tooth surface are machined by different processes. For example, JP H05-177434 A discloses that a hob cutter 5 and an outer diameter machining tool 7 are positioned so as to be associated with a gear W to be machined, an outer diameter of gear W is simultaneously machined or ground by tool 7 when gear W is cut by hob cutter 5, and then, an inner diameter of gear W is machined with reference to the outer diameter of gear W.

In the machining process of JP H05-177434 A, tooth surface machining tool 5 and tooth top surface machining tool 7 are positioned associated with rotating body W, the tooth top surface of rotating W is simultaneously machined or ground by tool 7 when rotating body W is cut by tool 5 (or when teeth are formed on rotating body W by tool 5), and then, the inner diameter of rotating body W is machined (or the inner diameter is finish machined) with reference to the outer diameter of rotating body W. In other words, the tooth top surface and the tooth surface are machined using different processes.

FIG. 9 shows a conventional method for manufacturing a rotating body. In this method, as shown in a section (a) of FIG. 9, a tooth top surface grinding stone 114 is used to form a tooth top surface on a rotating body 100a, and then, as shown in a section (b) of FIG. 9, a tooth surface grinding stone 116 is used to form a tooth surface on the rotating body. By virtue of this, rotating body 100a having a tooth shape as shown in FIG. 10 is obtained. However, in such a manufacturing method, burrs 118a may form at or near a boundary between tooth top surface 108a and tooth surface 112a, and protrude radially and outwardly from the boundary.

FIG. 11 shows another conventional method for manufacturing a rotating body. In this method, as shown in a section (a) of FIG. 11, a tooth surface grinding stone 116 is used to form a tooth surface on a rotating body 100b, and then, as shown in a section (b) of FIG. 11, a tooth top surface grinding stone 120 is used to form a tooth top surface on the rotating body. By virtue of this, rotating body 100b having a tooth shape as shown in FIG. 12 is obtained. However, in such a manufacturing method, burrs 118b may form at or near a boundary between tooth top surface 108b and tooth surface 112b, and protrude in a circumferential direction from the boundary.

In the conventional manufacturing method as explained by using FIGS. 9 to 12, wherein the tooth top surface and the tooth surface of the gear-shaped rotating body are machined by the different processes, scraped shapes or seams are formed on tooth top surface 108 in the circumferential direction (or in the direction of an arrow 122), and scraped shapes or seams are formed on tooth surface 112 in the axial (tooth trace) direction (or in the direction of an arrow 124), as shown in FIG. 13. Further, burrs 118 may form at or near the boundary between the tooth top surface and the tooth surface, and therefore detection accuracy of a magnetic angle detector may be lowered.

The detection accuracy of a magnetic angle detector may also be lowered due to a positional error between the tools used in the different processes, as well as the formed burrs. For example, as exaggeratingly shown in FIG. 14, since the tooth top and the tooth bottom are not concentric with each other, portions 126 and 128 may be formed, i.e., portion 126 where the size of a tooth (or the distance between the tooth bottom and the tooth top surface) of rotating body 100 is relatively small, and portion 128 where the size of a tooth of rotating body 100 is relatively large. When the teeth of the rotating body have the different sizes as described above, the detection accuracy of the magnetic angle detector is lowered.

### SUMMARY OF THE INVENTION

Thus, the object of the present invention is to provide a method for manufacturing a rotating body of a magnetic angle detector, wherein the rotating body can be machined and manufactured with high accuracy without generating burrs, and also provide a rotating body manufactured by the method and a magnetic angle detector having the rotating body.

The present invention provides a method for manufacturing a rotating body of a magnetic angle detector, comprising: simultaneously machining a tooth top surface and a tooth surface of a tooth of the rotating body, by using one grinding stone having a tooth top surface grinding part which machines the tooth top surface and a tooth surface grinding part for grinding the tooth surface.

Further, the present invention provides a rotating body manufactured by the method of the invention.

Still further, the present invention provides a magnetic angle detector comprising the rotating body of the invention.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a schematic view for explaining an embodiment of a method for manufacturing a rotating body of a magnetic angle detector of the present invention, along with an enlarged view of the rotating body;

FIG. 2 is a view showing a detail of a shape of a tooth of the rotating body manufactured by the method of the invention;

FIG. 3 is a view showing a first structural example of a magnetic angle detector using the rotating body manufactured by the method of the invention;

FIG. 4 is a view showing a second structural example of a magnetic angle detector using the rotating body manufactured by the method of the invention;

FIG. 5 is a view showing a third structural example of a magnetic angle detector using the rotating body manufactured by the method of the invention;

FIG. 6 is a view showing a fourth structural example of a magnetic angle detector using the rotating body manufactured by the method of the invention;

FIG. 7 is a view showing a conventional magnetic angle detector having a rotating body with a gear shape and a detecting part;

FIG. 8 is a view showing an example of a method for angle detection using the conventional magnetic angle detector;

FIG. 9 is a view showing a method for manufacturing a rotating body of the conventional magnetic angle detector;

FIG. 10 is a view showing a detail of a shape of a tooth of the rotating body manufactured by the method of FIG. 9;

FIG. 11 is a view showing another method for manufacturing a rotating body of the conventional magnetic angle detector;

FIG. 12 is a view showing a detail of a shape of a tooth of the rotating body manufactured by the method of FIG. 11;

FIG. 13 is a view showing a detail of a shape of a tooth of the rotating body manufactured by the conventional method; and

FIG. 14 is a view showing an example wherein the sizes of teeth of the rotating body manufactured by the conventional method are not uniform.

### DETAILED DESCRIPTION

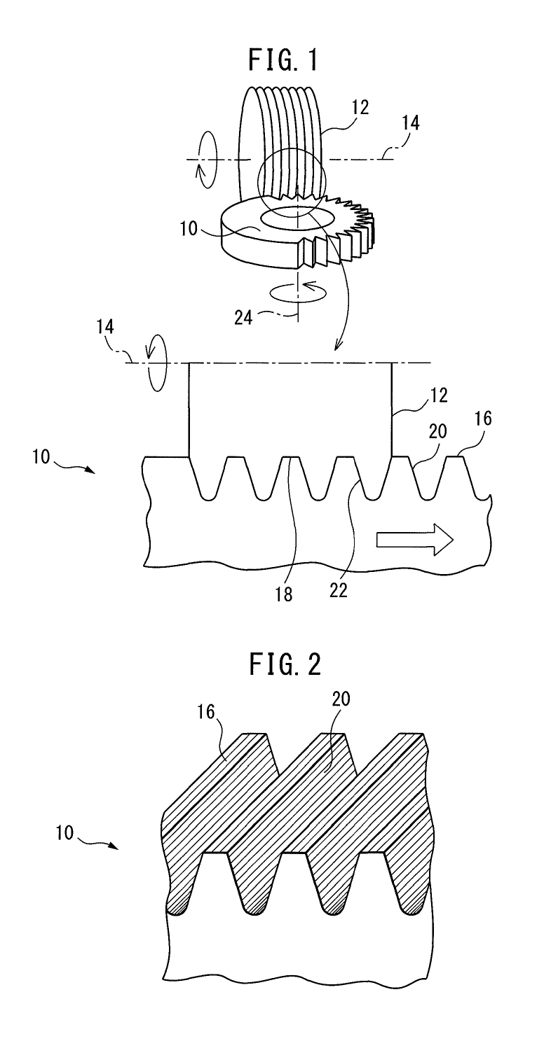

FIG. 1 is a schematic view for explaining an embodiment of a method for manufacturing a rotating body of a magnetic angle detector of the present invention. A portion of a rotating body 10 other than teeth thereof may be the same as a portion of rotating body 100 manufactured by the conventional method as described above. In the present invention, a tooth top surface and a tooth surface of a tooth, which are to be formed on rotating body 10, are simultaneously formed by means of one grinding stone 12. Concretely, as shown in an enlarged view of FIG. 1, grinding stone 12 has a generally hob-shape rotatable about an axis 14, and has a tooth top surface grinding part 18 which machines a tooth top surface 16 of a tooth to be formed on rotating body 10, and a tooth surface grinding part 22 which machines a tooth surface 20 of the tooth to be formed on rotating body 10. Grinding stone 12 is configured to simultaneously grind and machine tooth top surface 16 and tooth surface 20 by rotational grinding about axis 14.

Rotating body 10 is configured to rotate about an axis 24 which is perpendicular to rotation axis 14 and does not intersect with axis 14. By virtue of this, grinding stone 12 can form a gear shape onto rotating body 10 over an entire circumference thereof by grinding process. In this regard, although rotating body 10 has a gear shape similar to a mating gear used for power transmission, rotating body 10 may have any gear shape as long as it can be applied to a magnetic angle detector as explained below.

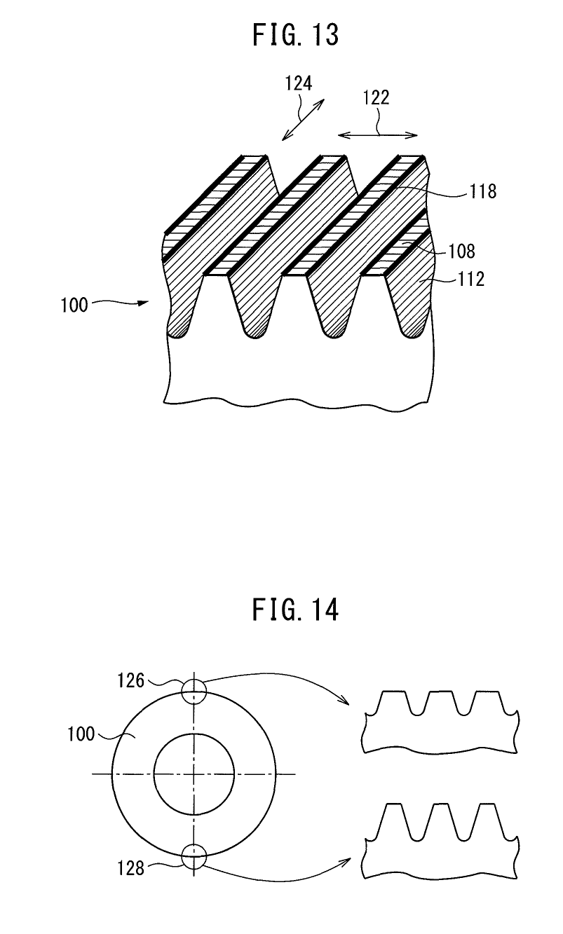

FIG. 2 is a view showing a detail of the shape of a tooth of rotating body 10 manufactured by the manufacturing method of the invention. As is apparent from the comparison with FIG. 13 showing rotating body 100 machined by the conventional manufacturing method, in rotating body 10, scraped shapes or seams are formed in the tooth trace direction (or the direction along axis 24) on both tooth top surface 16 and tooth surface 20, and there is no formed burr at the boundary between tooth top surface 16 and tooth surface 20. Further, by machining tooth top surface 16 and tooth surface 20 by means of one grinding stone 12, the tooth top and tooth bottom can be concentric with high accuracy. Therefore, in the invention, non-uniformity of the size of each tooth as shown in FIG. 14 does not occur, and therefore a magnetic angle detector with high detection accuracy is provided.

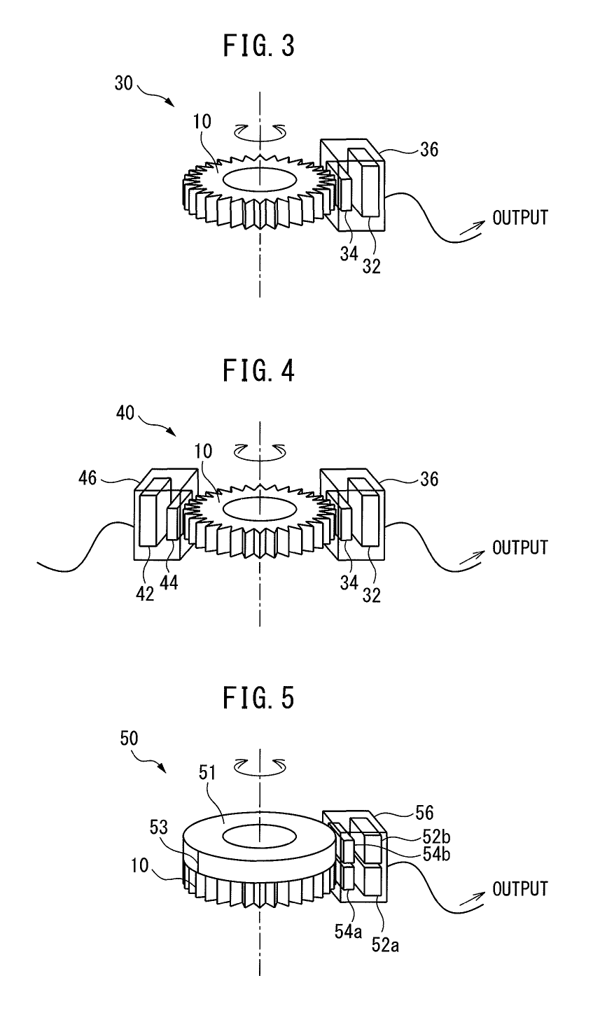

FIGS. 3 to 6 show structural examples of a magnetic angle detector using rotating body 10 machined by the manufacturing method of the invention. First, as shown in FIG. 3, although a magnetic angle detector 30 has a configuration similar to the conventional magnetic angle detector as shown in FIG. 7, magnetic angle detector 30 uses rotating body 10 machined by the manufacturing method of the invention. Concretely, magnetic angle detector 30 has rotating body 10 having the tooth top surface and the tooth surface which are simultaneously machined by one grinding stone, and a detection unit 36 including a magnet 32 and a magnetic detecting part (element) 34, wherein magnetic detecting element 34 is positioned between rotating body 10 and magnet 32.

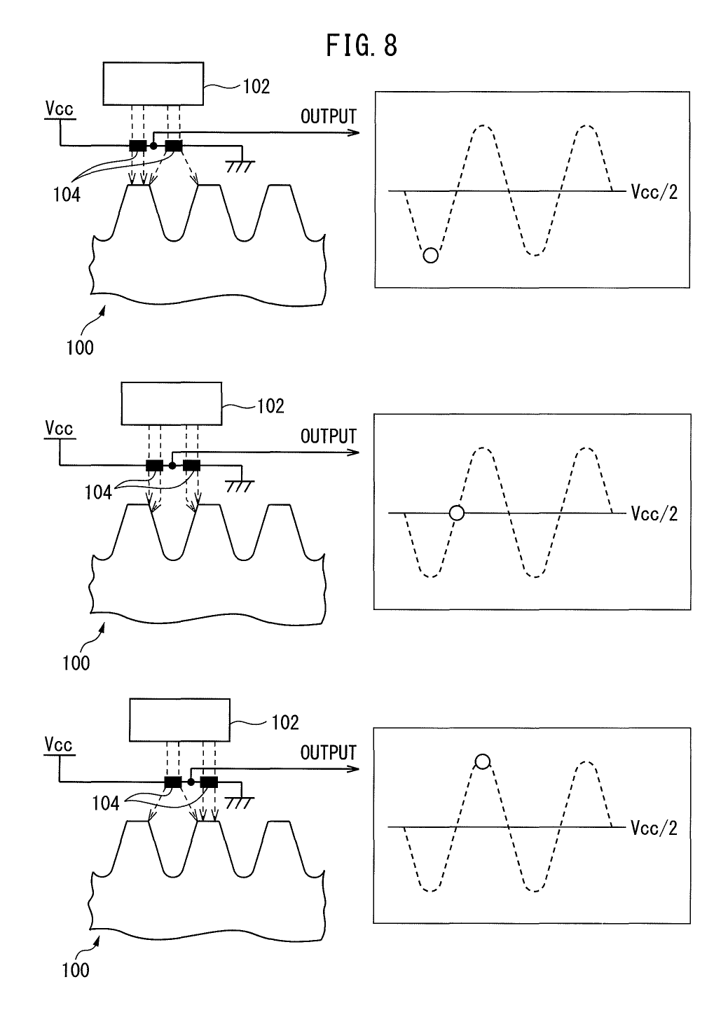

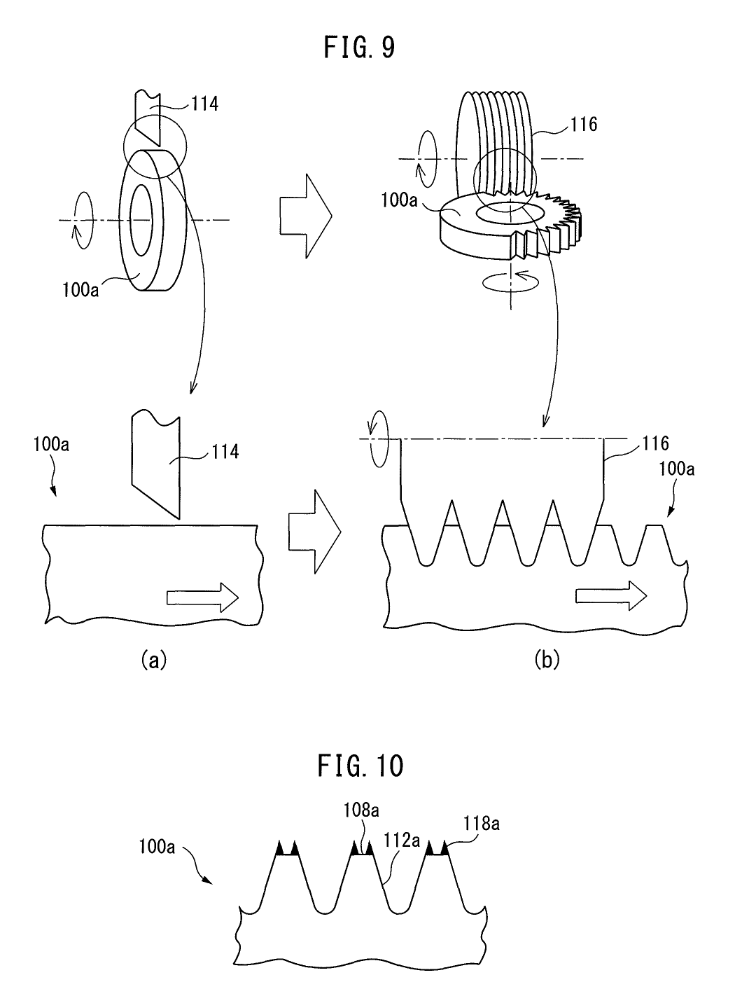

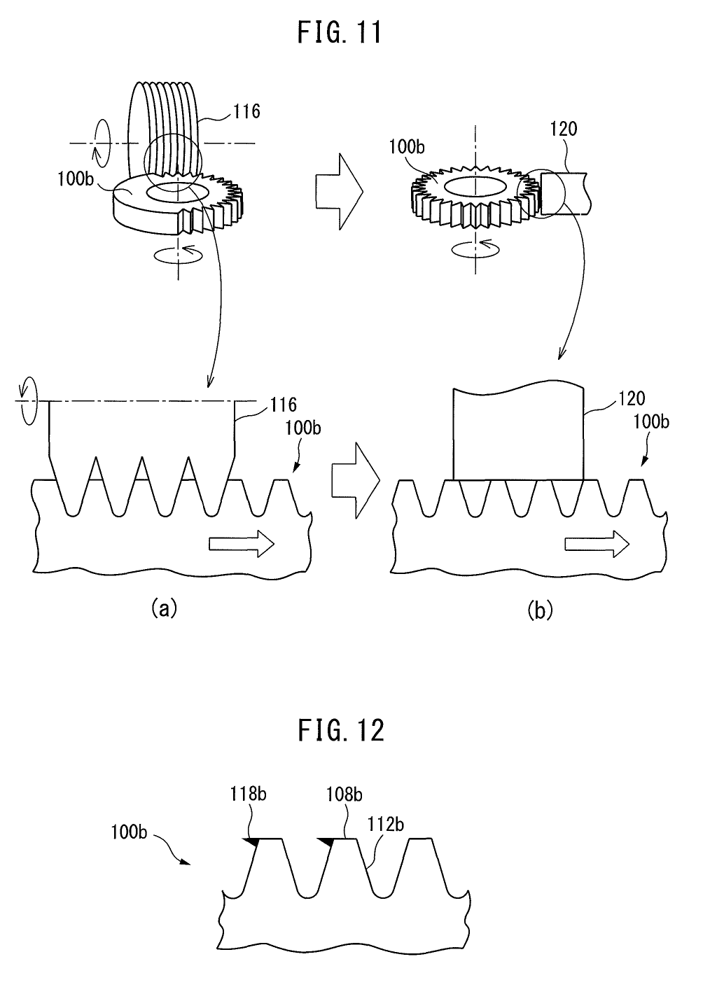

Since a method for detecting the angular position of rotating body 10 in detection unit 36 may be similar to the method of FIG. 8, a detailed explanation thereof will be omitted. In the example of FIG. 3, by means of rotating body 10 having the tooth top surface and the tooth surface which are simultaneously machined by one grinding stone, error causes of the rotating body such as burrs or non-uniformity of the size of each tooth may be eliminated, whereby the angular position of the rotating body can be accurately detected.

A magnetic angle detector 40 as shown in FIG. 4 is different from magnetic angle detector 30 of FIG. 3, in that detector 40 has two detection units. Concretely, magnetic angle detector 40 has rotating body 10 having the tooth top surface and the tooth surface which are simultaneously machined by one grinding stone, detection unit 36 similar to the detection unit explained with reference to FIG. 3, and a second detection unit 46 including a magnet 42 and a magnetic detecting part (element) 44, wherein detection units 36 and 46 are positioned at predetermined positions (for example, at opposed positions in relation to rotating body 10) so as to be separated from each other. Second detection unit 46 may have a configuration similar to detection unit 36, and magnetic detecting element 44 is positioned between rotating body 10 and magnet 42.

Since a method for detecting the angular position of rotating body 10 in detection units 36 and 46 may be similar to the method of FIG. 8, a detailed explanation thereof will be omitted. In the example of FIG. 4, by means of two detection units 36, 46 and rotating body 10 having the tooth top surface and the tooth surface which are simultaneously machined by one grinding stone, an error inherent in the rotating body can be eliminated, and further, an error due to the eccentricity of the rotating body can be prevented by means of the two detection units. Therefore, the angular position of the rotating body can be accurately detected.

A magnetic angle detector 50 as shown in FIG. 5 is different from magnetic angle detector 30 of FIG. 3, in that detector 50 has two kinds of detected parts. Concretely, magnetic angle detector 50 has rotating body 10 having the tooth top surface and the tooth surface which are simultaneously machined by one grinding stone, and a second rotating body (detected part) 51 positioned adjacent to rotating body 10 so as to be concentric with rotating body 10, wherein rotating body 10 and second rotating body 51 are integrally rotated. Second rotating body 51 has at least one recess or protruberance 53 formed on an outer cylindrical surface thereof. The number of recess or protruberance 53 is less than the number of the teeth of rotating body 10, and in many cases, the number of recess or protruberance 53 is one. In addition, regarding the two detected parts, magnetic angle detector 50 has a third detection unit 56 including two magnets 52a and 52b and magnetic detecting parts (elements) 54a and 54b. Magnetic detecting element 54a is positioned between rotating body 10 and magnet 52a, and magnetic detecting element 54b is positioned between second rotating body 51 and magnet 52b.

Since a method for detecting the angular positions of rotating body 10 and second rotating body 51 in third detection unit 56 may be similar to the method of FIG. 8, a detailed explanation thereof will be omitted. In the example of FIG. 5, by means of rotating body 10 having the tooth top surface and the tooth surface which are simultaneously machined by one grinding stone and second rotating body 51 different from rotating body 10 and substantially integrally formed with rotating body 10, an error inherent in the rotating body can be eliminated, and further, an absolute angular position of the rotating body can be accurately detected.

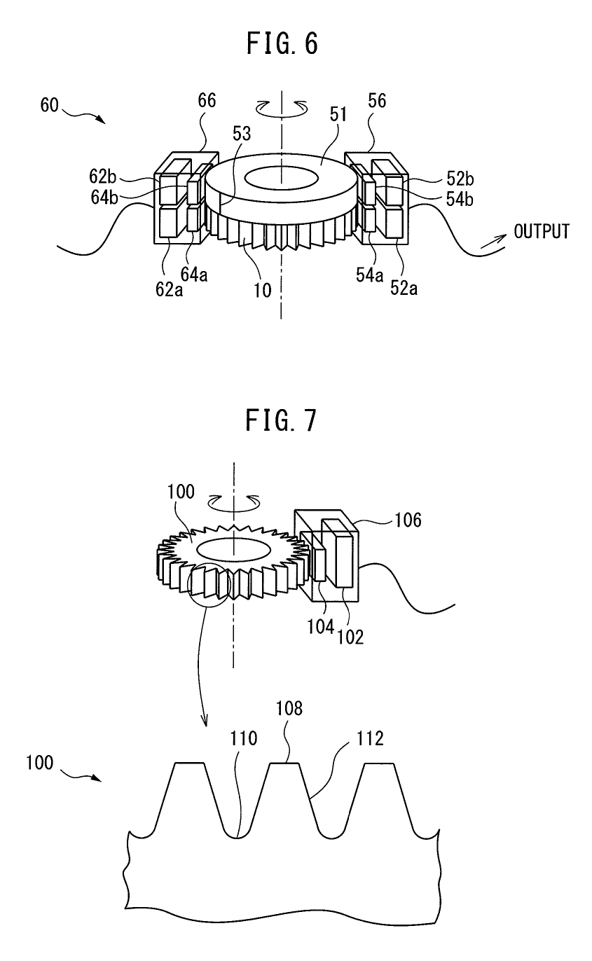

A magnetic angle detector 60 as shown in FIG. 6 is different from magnetic angle detector 50 of FIG. 5, in that detector 60 has two detection units. Concretely, magnetic angle detector 60 has rotating body 10 having the tooth top surface and the tooth surface which are simultaneously machined by one grinding stone, a second rotating body (detected part) 51 positioned adjacent to rotating body 10 so as to be concentric with rotating body 10 so as to be rotated integrally with rotating body 10, third detection unit 56 similar to the detection unit explained with reference to FIG. 5, and a fourth detection unit 66 including two magnets 62a and 62b and magnetic detecting parts (elements) 64a and 64b. Third detection unit 56 and fourth detection unit 66 are positioned at predetermined positions (for example, at opposed positions in relation to rotating body 10 and second rotating body 51) so as to be separated from each other. Fourth detection unit 66 may have a configuration similar to third detection unit 56. Magnetic detecting element 64a is positioned between rotating body 10 and magnet 62a, and magnetic detecting element 64b is positioned between second rotating body 51 and magnet 62b.

Since a method for detecting the angular positions of rotating body 10 and second rotating body 51 in detection units 56 and 66 may be similar to the method of FIG. 8, a detailed explanation thereof will be omitted. In the example of FIG. 6, by means of two detection units 56 and 66, rotating body 10 having the tooth top surface and the tooth surface which are simultaneously machined by one grinding stone and second rotating body 51 different from rotating body 10 and substantially formed integral with rotating body 10, an error inherent in the rotating body can be eliminated, and further, an error due to the eccentricity of the rotating body can be prevented by means of the two detection units, and an absolute angular position of the rotating body can be accurately detected.

According to the method for manufacturing a rotating body of the present invention, the tooth top surface and the tooth surface of the rotating body are simultaneously machined by one grinding stone. Therefore, man-hours for manufacturing the rotating body can be reduced, and the rotating body having no burrs and teeth with uniform sizes and shapes can be obtained. Further, when the rotating body is applied to a magnetic angle detector such as an encoder, the detection accuracy of the angular position can be significantly improved.

While the invention has been described with reference to specific embodiments chosen for the purpose of illustration, it should be apparent that numerous modifications could be made thereto, by one skilled in the art, without departing from the basic concept and scope of the invention.

1. A method for manufacturing a rotating body of a magnetic angle detector, comprising:
simultaneously machining a tooth top surface and a tooth surface of the rotating body, by using one grinding stone having a tooth top surface grinding part which machines the tooth top surface and a tooth surface grinding part which machines the tooth surface.

2. A rotating body manufactured by the method as set forth in claim 1.

3. A magnetic angle detector comprising the rotating body as set forth in claim 2.
